(19) United States
(12) Patent Application Publication
(10) Pub. No.: US 2026/0063857 A1
(43) Pub. Date: Mar. 5, 2026

(54) OPTICAL INTERCONNECT DESIGN FOR ACTIVE SHORT DISTANCE LINKS

(71) Applicant: Hyperlume Inc., Ottawa (CA)

(72) Inventors: Ehsan Alimohammadian, Ottawa (CA); Mohsen Asad, Ottawa (CA); Hossein Fariborzi, Auburndale, MA (US)

(73) Assignee: Hyperlume Inc., Ottawa (CA)

(21) Appl. No.: 19/055,093

(22) Filed: Feb. 17, 2025

Related U.S. Application Data
(63) Continuation of application No. PCT/CA2024/051137, filed on Aug. 30, 2024.

(51) Int. Cl. G02B 6/42; G02B 27/00; H04B 10/80

(52) U.S. Cl. CPC G02B 6/4221; G02B 27/0012; H04B 10/801

(57) ABSTRACT

An optical interconnect system comprising: at least one light source for emitting light, the light comprising a distribution pattern having a predefined divergence angle; at least one communication medium for transmitting the light, wherein the at least one communication medium comprises a numerical aperture, and wherein at least one of the numerical aperture, the at least one light source, the predefined divergence angle, and the at least one communication medium, is dimensioned to minimize loss of optical power coupling of the light into the at least one communication medium; at least one light detector for receiving the light from the at least one communication medium; at least one optomechanical alignment system configured to optimize collection of the light at the least one light detector.

### CROSS-REFERENCE TO RELATED APPLICATIONS

The instant application claims priority to PCT application PCT/CA2024/051137 with an international filing date of Aug. 30, 2024, presently pending. The contents of each application are hereby incorporated by reference.

### FIELD

Aspects of the disclosure relate to communication methods and systems.

### BACKGROUND

Energy consumption is a major challenge in scaling cloud computing power to address today's artificial intelligence (AI) needs. Today's AI requires vast computational power, which leads to high energy consumption. The chip-to-chip connection with an optical link addresses the required processing speed. High bandwidth, low-power, and highly scalable visible light emitting diodes (LEDs) as a reliable source may replace laser sources widely used in optical links for short-distance visible communications with minimum latency. Micro-LEDs offer a longer lifetime, lower power consumption, and lower cost than laser diodes.

LEDs generate light with Lambertian spatial patterns, which are inefficient compared to laser diodes when coupled into the standard single mode or multimode with a numerical aperture (NA) in the range of 0.14 to 0.3. A lens may be added to enhance light extraction efficiency by minimizing the refractive index mismatch in the flat semiconductor-air interface. Moreover, the lens tailors the spatial shape of the emitted pattern, forming a more directional light distribution and enhancing the coupling efficiency. However, encapsulating LED in a lens increases the footprint and adds to the cost of mass manufacturing, particularly when an array of the micro-LED is required to reach multiple parallel optical links in a cable. A microlens (ML) or a micro-lens array (MLA) may be added to the head of micro-LEDs (or micro-LED array) to allow for a smaller footprint with a less efficient solution due to low NA (less than 0.4), high cost, and scalability issue.

### SUMMARY

In one of its aspects, an optical interconnect system comprising:
at least one light source for emitting light, the light comprising a distribution pattern having a predefined divergence angle;
at least one communication medium for transmitting the light, wherein the at least one communication medium comprises a numerical aperture, and wherein at least one of the numerical aperture, the at least one light source, the predefined divergence angle, and the at least one communication medium, is dimensioned to minimize loss of optical power coupling of the light into the at least one communication medium;
at least one light detector for receiving the light from the at least one communication medium;
at least one optomechanical alignment system configured to optimize collection of the light at the least one light detector.

In another of its aspects, a method for assembling an optical interconnect system, the method comprising the steps of:
providing at least one light source for emitting light, wherein the emitted light comprises a distribution pattern;
determining a diameter and a divergence angle of the at least one light source;
providing at least one communication medium for transmitting the light, wherein the at least one communication medium comprises a numerical aperture, and wherein at least one of the numerical aperture, the at least one light source, the predefined divergence angle, and the at least one communication medium, is dimensioned to minimize loss of optical power coupling of the light into the at least one communication medium;
providing at least one light detector for receiving the light from the at least one communication medium; and
providing at least one alignment system to optimize collection of the light at the least one light detector.

The methods and systems described use high NA glass and plastic fibers or high NA imaging fiber bundles and associated optical and mechanical components and configurations to enable optimized light collection. Since short-distance connection is the main goal of these optical cables, the propagation loss and dispersion are less critical for the guiding fiber, and fiber larger diameter fibers and/or high NA fibers may be employed. Based on the size of the micro-LED source and the divergence angle, an optical fiber with a diameter large enough and high enough NA is used in the apparatus to maintain the low loss optical power coupling into the fiber. Employing high NA fibers allows higher optical misalignment errors in the system, enabling passive alignment of the components in the production line and thereby reducing the costs and scalability of the design. By optimizing the fiber diameter and NA, the etendue of the micro-LED source can be maximally preserved. Moreover, mechanical fiber ferrules for various fiber types and electronic board arrangements are included with the apparatus. The apparatus employs high NA fibers and/or imaging fibers along with end-coupling to maximize the coupling of micro-LED sources, which is not as directional as laser sources. The short-distance link required for chip-to-chip or board-to-board communication minimizes the impact of the optical dispersion, allowing for large-diameter fibers to be used for light delivery in higher bandwidth conditions. The low coupling loss in an LED-based visible communication link is the key to the low-power and high data rate chip-to-chip communication link.

### BRIEF DESCRIPTION OF THE DRAWINGS

Several exemplary embodiments of the present disclosure will now be described, by way of example only, with reference to the appended drawings in which:

FIG. 1 shows a schematic of a prior-art active cable based on a laser diode and photodiode as transmitter and receiver, respectively;

FIG. 2 shows a schematic of a prior-art multi-channel active cable with a two-dimensional array of light sources and detectors as transmitter and receiver, respectively;

FIGS. 3a and 3b depict conceptual drawings of prior art employing the low numerical aperture fibers with or without optics to collect LED light with a Lambertian pattern;

FIGS. 4a and 4b show optical interconnect arrangements comprising large numerical aperture fibers to maximize the preservation of the light source's etendue;

FIG. 5 shows a flowchart outlining example steps designing an optical interconnect system;

FIG. 6 shows a schematic of a single-channel active cable employing a high NA fiber in an end coupling arrangement with a flipped board;

FIG. 7 shows a schematic of a single-channel active cable similar to FIG. 6 with coupling optics;

FIG. 8 shows an arrangement in a single imaging fiber with the required optical elements to image the plane where both micro-LED and micro-PD arrays are located;

FIG. 9 shows a vertical and compact arrangement with a single imaging fiber, with the required optics to image the plane with both micro-LED and micro-PD arrays;

FIG. 10 shows an arrangement in which two imaging optical fibers with required optics in front of them image the micro-LED array plane and micro-PD array plane;

FIG. 11 shows a vertical and compact arrangement with two imaging fibers, with the required optics to image the micro-LED and micro-PD planes separately;

FIG. 12a shows an example of a ferrule that positions an array of fibers in a vertical arrangement;

FIG. 12b shows an example of a ferrule that positions an array of fibers in a horizontal arrangement;

FIG. 13a shows an example vertical arrangement of ferrule designed to hold one large imaging fiber;

FIG. 13b shows an example horizontal vertical arrangement of ferrule a designed to hold one large imaging fiber;

FIG. 14a show an example of a vertical arrangement of ferrule designed for holding two separate imaging fibers;

FIG. 14b show an example of horizontal vertical arrangement of ferrule designed for holding two separate imaging fibers;

FIGS. 15a-c shows schematics of fiber-to-LED contact for various small-diameter fibers;

FIGS. 15d-f shows schematics of fiber-to-LED contact for various large-diameter fibers; and

FIG. 16 shows coupling efficiency simulations plotted as a function of numerical aperture (NA) for various misalignment errors ranging from m=0μm (no misalignment) to m=20μm.

### DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

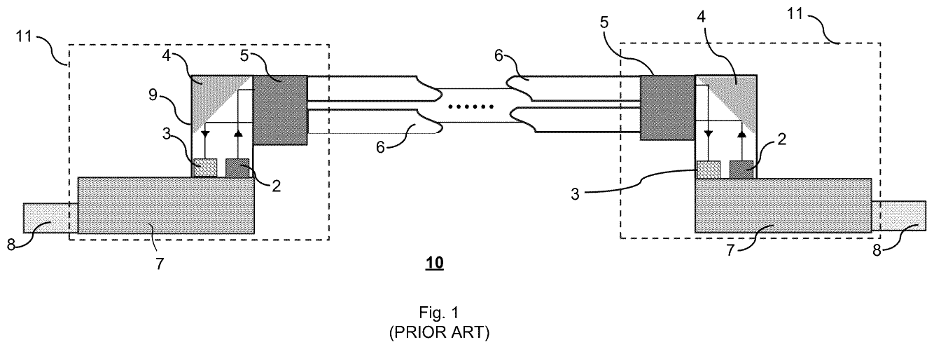

FIG. 1 shows a simplified example of the prior-art active optical cable assembly 10 used for high-speed communications over a long distance. The device includes a light source 2, such as a vertical-external-cavity surface-emitting laser (VECSEL), and a photodetector 3, such as a photodiode (PD). The light emitted by the sources on both sides is collected, channeled into the fiber, and delivered to the PDs on the other side of the active optical cable, enabling both send and receive functions. A 45-degree mirror or a prism 4 is employed to flip the beam to minimize fiber bending loss. There is also an optical arrangement 5 to couple the laser source 2 into the fiber 6 or focus the light on the PD 3. The optical communication fiber 6 is chosen to minimize the propagation loss over the distance. The fiber 6 may be a single-mode fiber (above two kilometers distance) or multimode fiber (less than about two kilometers). Single-mode operation of the fiber disables the model dispersion and low-loss operation in higher frequencies. Modal dispersion dictates the pulse width of multimode fibers, making them only suitable for shorter distance (less than two kilometers) communications. The optical arrangement is placed on the electronic board 7, which includes the driving and communication chips and the metallic connector 8. The optical system and the board require an optical cage 9 to precisely hold the optics in place with minimum misalignment and allow mass manufacturing. A casing 11 holds the entire device within an acceptable footprint matching the target application's mechanical specification.

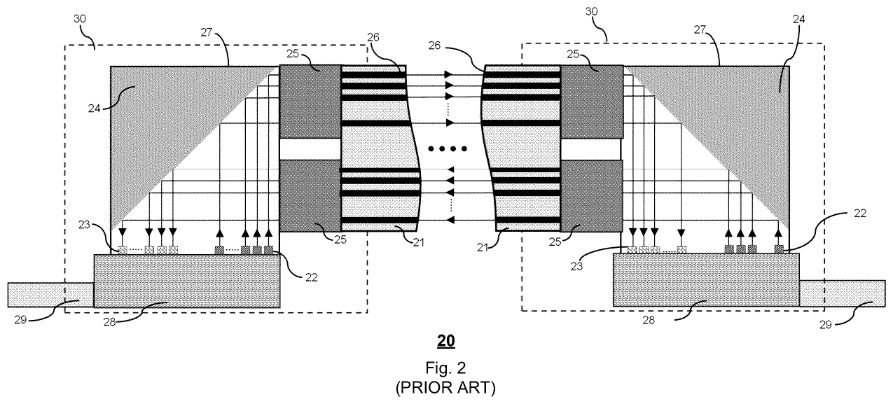

FIG. 2 shows a prior-art optical cable assembly 20 comprising parallel optical links in a single active optical cable. The optical cable assembly 20 comprises fibers 21, an array of light sources 22, such as, VECSELs, and photodetectors 23, on both sides. Optical prisms or 45-degree mirrors 24 are used on both sides of the fibers 21 to flip all the beams used in transmission and receiving lines to avoid bending the fibers 21. Optical components 25 are placed for efficient light coupling into fibers 21 and light delivery to corresponding PDs 23. The optical components and fibers 21 are configured to minimize cross-talks between various channels. A fiber bundle 26 includes several fibers 21 placed in an arrangement corresponding to the location of each light source 22 and each PD 23. A mechanical cage 27 holds the bundle 26, which may have a ferrule to hold the fibers 21 in the desired arrangement. The driving and communication electronics are placed on a board 28 with a metallic connector 29. The entire system 20 is packaged within a casing 30 having a footprint matching the target application's mechanical specification.

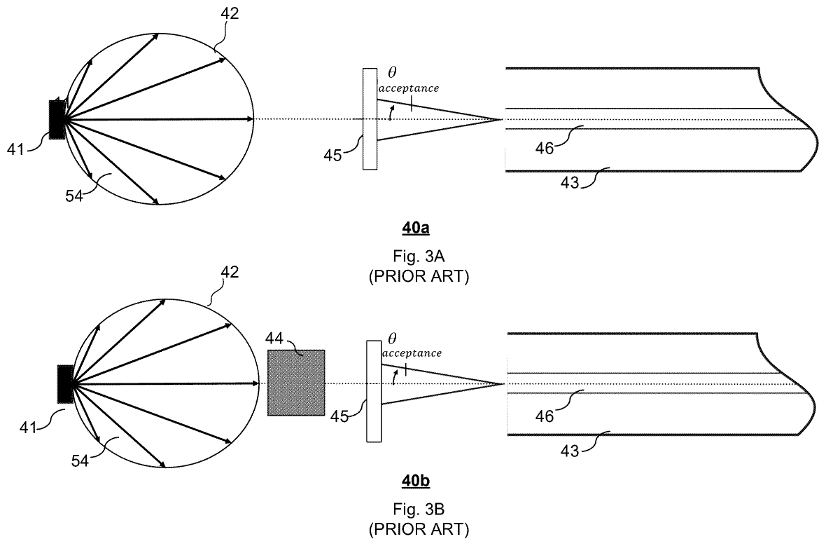

FIGS. 3a and 3b show schematics of prior art optical cable assemblies 40a, 40b used to collect the light from an LED source 41. The LED 41 generates a Lambertian distribution 42. In FIG. 3a, LED light source 41 is placed in front of a fiber facet of fiber 43, and the light is transmitted via the fiber core 46. In FIG. 3b, LED light source 41 is placed in front of coupling optics 44, such as encapsulating lens. The fiber 43 has an acceptance cone 45 with an angle of θacceptance which can be calculated based on the fiber's numerical aperture (NA). The fiber 43 may have an NA in the range of 0.14 to 0.3, with a single or multimode operation commonly used for kilometer communication distance based on state-of-the-art optical communication systems employing laser systems. Moreover, the prior-art assembly in FIG. 3 suits a directional light source, while an LED light source 41 that is not directional and the coupling efficiency to a low NA fiber would become inefficient.

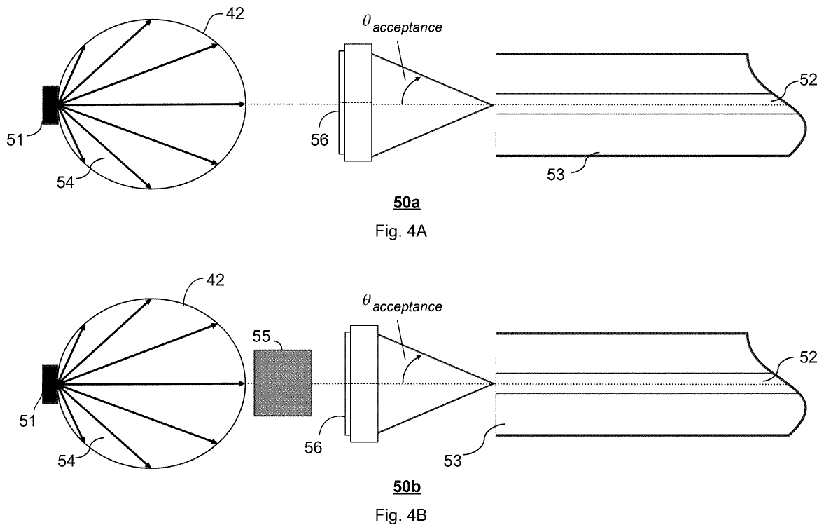

FIGS. 4a and 4b show an optical interconnect system 50a and 50b. In FIG. 4a, the optical interconnect system 50a comprises an LED light source 51 placed in front of a fiber facet 52 of fiber 53. The LED 51 generates a Lambertian distribution 54, and the light is transmitted via the fiber core 52. FIG. 4b shows an optical interconnect system 50b, comprising an LED light source 51 placed in front of coupling optics 55, such as an encapsulating lens. The fiber 53 has an acceptance cone 56 with an angle of θ acceptance which can be calculated based on the fiber's numerical aperture (NA). In one example, fiber 53's numerical aperture (NA) is large (above 0.3) with a large acceptance angle (θ). This allows for the maximum collection of the light from LED 51. As such, the optical interconnect system 50a, 50b is useful for short-distance communication in the scale of a couple of meters; therefore, dispersion would not play a significant role in distorting the single sent through the link. The large NA fiber 53 allows for better matching of the light source 51. Therefore, the optical interconnect system 150a, 50b takes advantage of LED 51's reliability and low power consumption and uses high NA fibers to enable a fiber optical link for chip-to-chip or board-to-board communication. Moreover, the optical interconnect system 51a, 51b may be used in two ways. In one method, the end coupling method can be used without any optics in between to couple the LED 51 light into the optical fiber 53, as shown FIG. 4a. In another method, an optical element may decrease the refractive index mismatch between the LED 51 and the optical fiber core 53 and improve the coupling and light extraction from the LED 51, as shown FIG. 4b. The coupling optics 56 may be attached to LED 51, such as a ball shape lens, or micro lenes, or any other optical element that increases the coupling efficiency. Other assemblies that are easy to mass-produce at a cheap cost are also feasible.

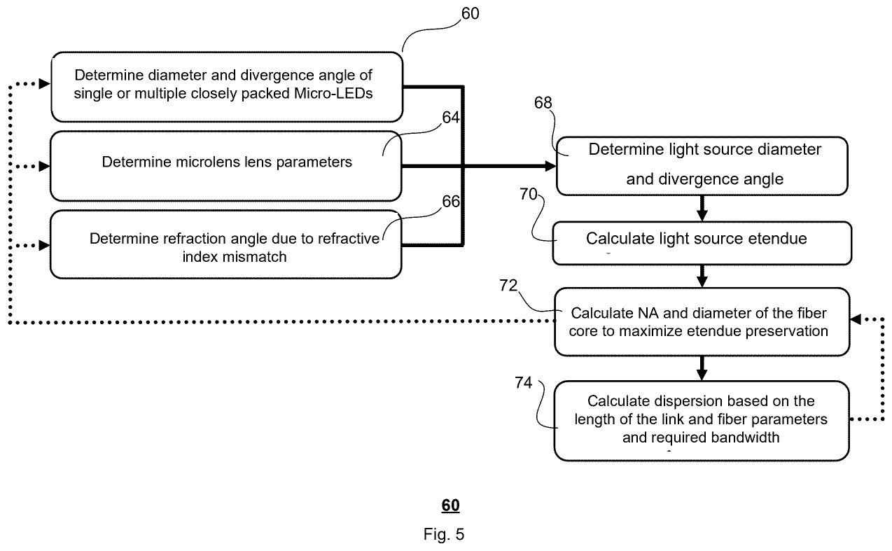

FIG. 5 shows a flowchart 60 outlining example steps for designing an optical interconnect system for enabling low-power and short-distance optical communication systems. With reference to FIGS. 4a, 4b, in step 62, the light source 51's diameter and divergence are determined. For example, a distribution pattern 54 of the LED 51 may be modelled and be used to evaluate the divergence angle or the light coupling efficiency into various fiber models. In one example, the light source 51 may be a single LED or closely-packed multiple LEDs 51 with or without any coupling elements 55 and/or index matching glue and/or substance. In step 64, the microlens parameters are determined. For the multiple micro-LEDs example, the arrangement of the LEDs 51 may be selected to maximize the delivered optical power. In step 66, if a microlens 56 is used to reduce the mismatch between the LED 51 surface and the fiber core 52, the parameters are considered to estimate the light source diameter and divergence. In step 68, the refraction angle is due to the refractive index mismatch between the LED 51 and fiber core 53, and the ultraviolet (UV) curable glue is considered in the calculation for the light source divergence angle. In step 70 knowing the light source parameter, the etendue of the light source 51 may be calculated. Then, in step 72, a fiber 53 with a certain diameter and NA may be selected to replace the initial fiber that was initially considered. In step 74, based on the required communication link length and bandwidth, and the fiber 53 parameters, the dispersion is calculated or experimentally evaluated and considered to set the maximum length and NA of the fiber 53 employed in the design. The process may be repeated iteratively to find optimum parameters for the refractive index matching glue, microlens parameters, LED sizes, and arrangement of multiple LEDs (in case multiple LEDs are used).

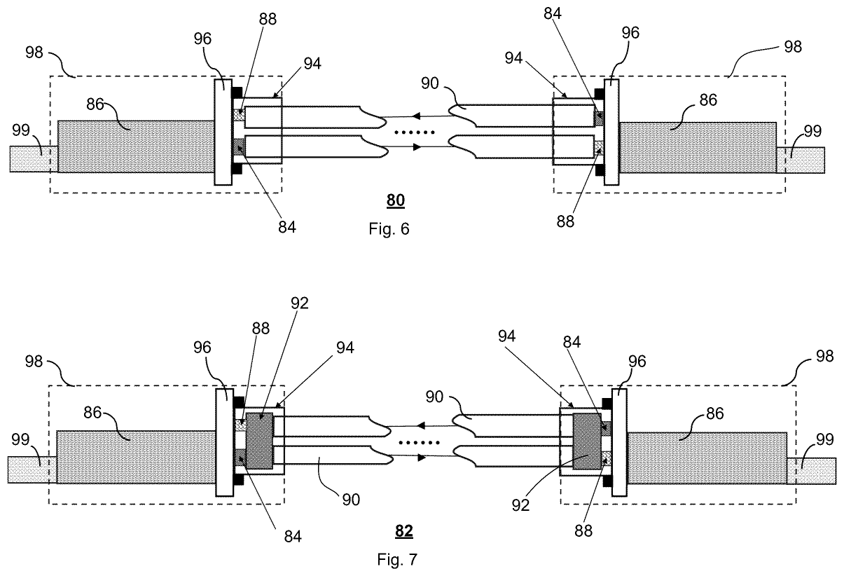

FIGS. 6 and 7 show two example configurations 80, 82, respectively, which employ a flipped arrangement for the light source 84 and PD board 86. Both examples use a micro-LED 84 or an array of micro-LEDs 84 and a PD 88 or an array of PDs 88 on both sides of the active optical cable 90. The LED 84 size is minimized to allow maximum light collection efficiency. A larger size PD 88 may be selected to allow high sensitivity. A high NA fiber 90 is used in both examples to collect the maximum amount of light emitted by the light source, which is either a single micro-LED 84 or an arrangement of micro-LEDs 84. FIG. 7 shows an example of optical elements such as micro-lens or other optics 92 that may be placed between the fiber core 90 and the LED 84 to increase the light extraction and coupling into the fiber 90. The optics 92 shown in FIG. 7 effectively deliver the light from the fiber 90 to the PD 88. The one or more optical components 92 may comprise several pieces individually designed for the corresponding PD 88 or light source 84. The one or more optical components 92 may comprise a tapered fiber or a fiber plate with a large enough NA to collect the maximum light. The high NA fiber 90, light source 84, and PD 88 may be capsulated in a ferrule 94 which allows for precise alignment of the fibers 90, PD 88, light source 84, and optical components 92. The optical arrangement, LEDs 84 and PDs 88 are placed on a flipped board 96 attached to the main electronic 86 board, which holds driving and communication chips and the metallic connector 99. The electronic boards 86 and the rest of the system 80, 82 are placed in a case 98 that is suitably dimensioned as specified by the target application's mechanical requirements.

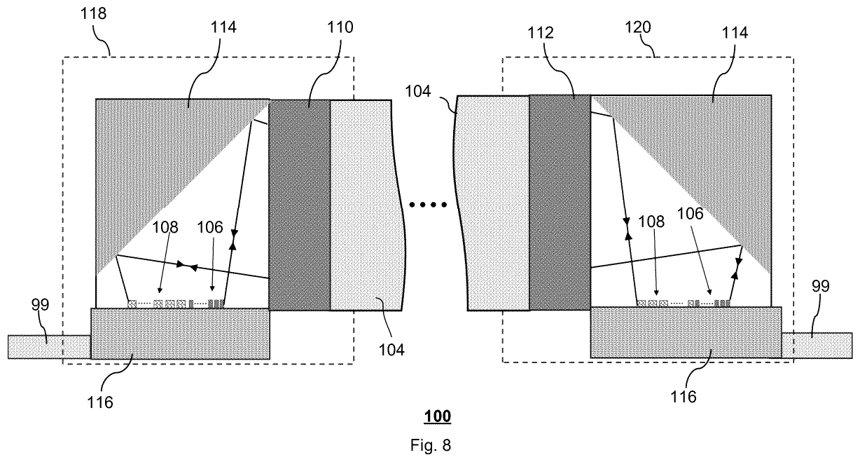

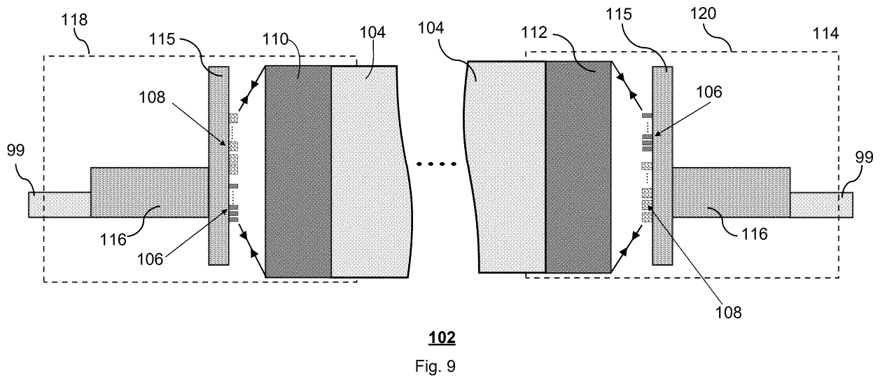

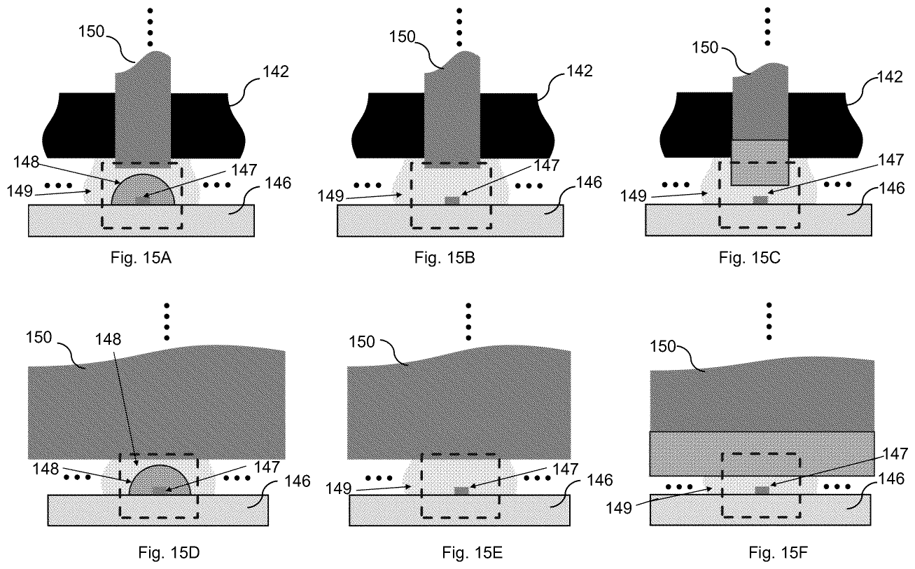

FIGS. 8 and 9 show two assemblies 100, 102, respectively, employing one imaging fiber 104 to light from an array of LEDs 106 and deliver it to an array of PDs 108. FIGS. 8 and 9 show horizontal and vertical assemblies 100, 102, respectively. Optical elements 110, 112, such as tapered fiber, fiber plates, or lenses, may facilitate imaging of the LED layer to the PD layer and couple the light in or out of the imaging fiber 104. The optical elements 110, 112 may have a focal length to image PD 108 or LED arrays 106 and, if needed, match the sizes to the guiding imaging fiber 104. As shown in FIG. 8, the imaging system 100 in the horizontal arrangement requires an element 114 to flip the beam 90 degrees, such as a mirror 45-degree mirror or a prism. In the vertical arrangement 102 of FIG. 9, the board 115 holding the micro-LED array 106 and PD array 106 is flipped with respect to the main electronics board 116. The fiber 104 has similar optics on both sides, however, the positions of the micro-LED array 106 and the micro-PD array 108 are different on each side to enable transmitting and receiving data. The contact between fiber 104 and the LED 106 may be as shown in any of the embodiments in FIG. 15. A mechanical case 118, 120 encapsulates all the elements, and keeps all the optical components aligned with the required alignment accuracy dictated by the imaging system 100, 102, including the imaging fiber 104 and other optical components. The size of the mechanical case 118, 120 is suitably dimensioned as specified by the target application's mechanical requirements. The case 118, 120 size may be different or similar for the horizontal and vertical assemblies.

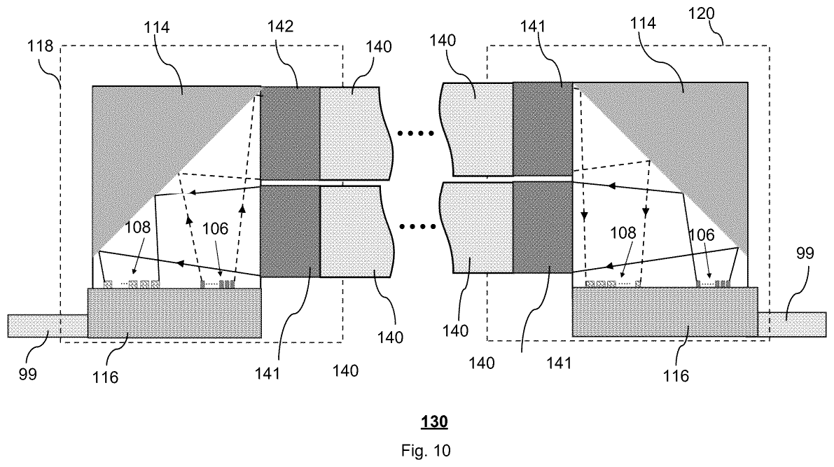

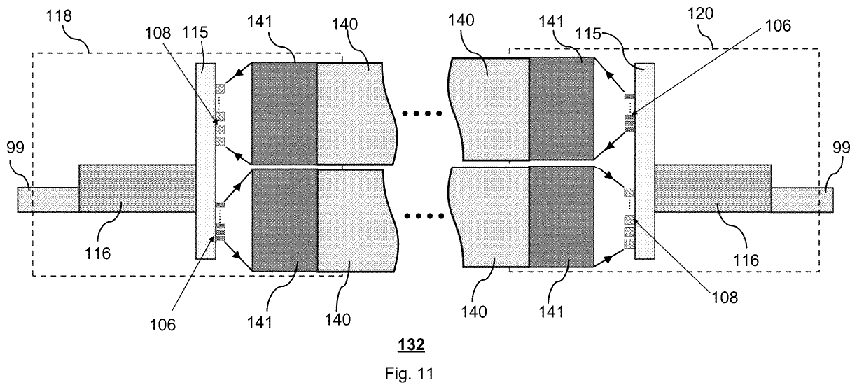

FIGS. 10 and 11 show two assemblies 130, 132, respectively, employing an array of LEDs 106 delivering light to two imaging fibers 140 for transmission to an array of PDs 108. FIGS. 10 and 11 show horizontal and vertical assemblies, respectively. In FIG. 10, two separate imaging fibers 140 are used for transmitting and receiving data since the imaging optics 141, 142 for each may differ due to their size. Both assemblies are similar to the ones discussed in FIGS. 8 and 9, with the difference of using two imaging fibers 140 and their corresponding optical components 141, 142. This arrangement allows for separate designs of each optical component attached to the tip of the imaging fibers 140, enabling more degrees of freedom. Each optical component on each end 142, 141 may be designed to match the target imaging plain with any PD 108 or LED array 106 size. This is beneficial in the system design when, for instance, the array size of micro-LEDs 106 and micro-PDs 108 do not match. An optimum system design in which the energy consumption is minimized may, for instance, require a larger PD 108 size and smaller LED 106 size. The LED 106 and PD 108 size determines the array size that is to be imaged and guided through the optical imaging fiber 140. In FIG. 11, each fiber 140 has two different ends, one of which images the micro-PD array 108 and the other of which images the micro-LED plane. The contact between fiber 104 and the LED 106 may be as shown in any of the embodiments in FIG. 15.

Moreover, similar to the schematic shown in FIG. 2, multiple parallel bundles of channels may be established with several imaging fibers 140. This would enable a high data rate to be transferred in parallel using several imaging fibers 140 through each array of LED 106 and PD 108. Multiple channels may be established based on the number of LEDs 106 and PDs 108 used in each array.

Furthermore, in another example, the optical components on the top of the fibers, in FIGS. 6 to 11, may be eliminated.

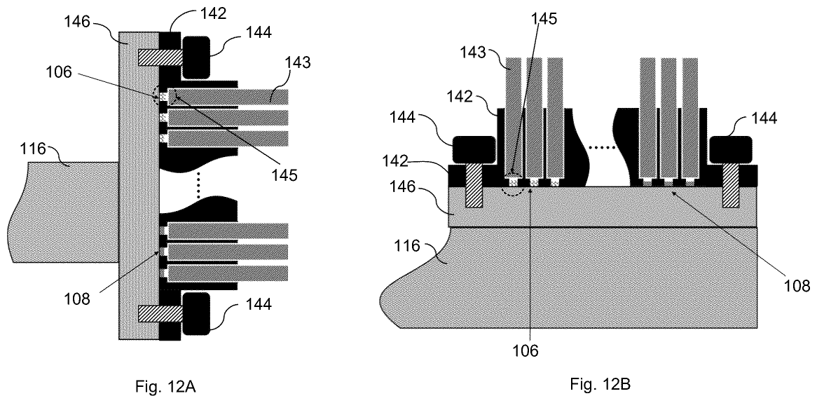

FIGS. 12a, 12b show a main board 116, micro-LED and PD board 146, and a mechanical ferrule 142 for holding multiple high NA optical fibers 143 in vertical and horizontal assemblies, respectively. The fibers 143 are high NA and may have various diameters, and the ferrule 142 may be used, but is not limited to two fiber systems shown in FIGS. 6 and 7. The ferrule 142 comprises a screw or pin or alignment fiducial or a similar mechanical component 144 for aligning the micro-LED and PD board 146 and precisely with the fiber tips and or the one or more optical elements attached to the fiber tips and or the one or more optical elements placed precisely in the ferrule 142. An example of an optical element may be include, but is not limited to, lenses, fiber plates, and tapered fibers.

The ferrule 142's design and fabrication method is geared towards precise positioning with minimum misalignment. As such, the ferrule 142 enables precise alignment of the fiber core center and micro-LED 106 or micro-PD 108, and the spacing between the fiber tip and any optics placed on the fiber tips. The ferrule 142 material has a thermal characteristic that satisfies the target application requirement to minimize temperature dependency on the optical alignment. The contacts 145 between the fiber tips and the LED 106 or PD 108 facilitate optimum, low-energy operation. FIG. 15 illustrates various examples of fiber tips and micro-LED or PD contacts 145.

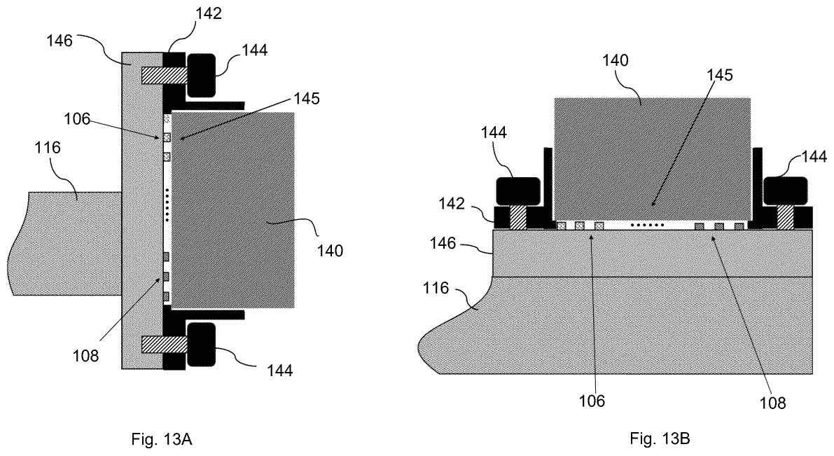

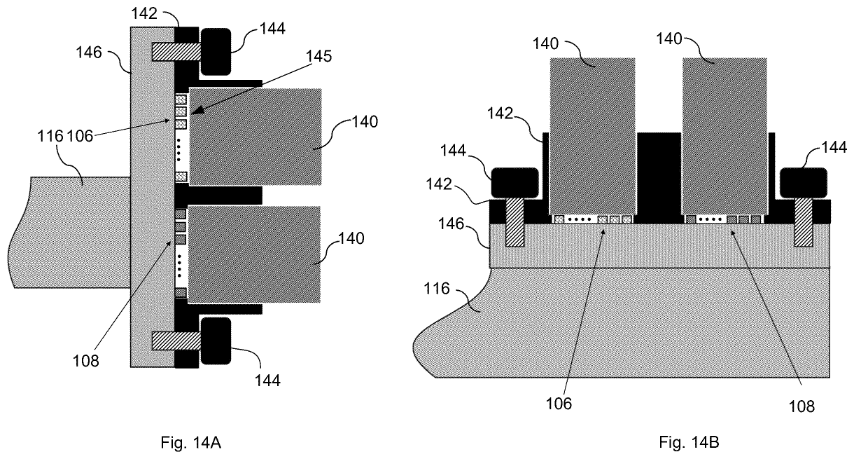

FIGS. 13a, 13b and 14a, 14b show a main board 116, micro-LED and PD board 146, and ferrules 142 that hold single or two imaging fibers 140 aligned with respect to the PD 108 or LED 106 planes, respectively. FIGS. 13a and 14a depict vertical assemblies, while FIGS. 13b and 14b depict horizontal assemblies. The contact between fiber 104 and the LED 106 may be as shown in any of the embodiments in FIG. 15. The assemblies of FIGS. 13a, 13b and 14a, 14b described herein comprise an alignment pin, fiducial, or screw 144. The number of imaging fibers 140 may be one, as shown in FIGS. 13a, 13b, or two imaging fibers 140, as shown in FIG. 14, or more imaging fibers 140, in other embodiments. Various optical components may also be placed on the fiber tip or between the fiber 140 and LED 106 or PD 108 arrays in some assemblies. These optical components include but are not limited to lenses, fiber plates, and taper fibers. The contacts 145 between the imaging fiber tips and the LED 106 or PD 108 are included in the system for facilitating optimum, low-energy operation. FIG. 15 illustrates various examples of fiber tips and micro-LED or PD contacts.

Furthermore, the optical components on the top of the fibers in FIGS. 6 to 11 may be placed in the ferrules 142 shown in FIGS. 12 to 14, which is another example of innovation. The ferrules 142 shown in FIGS. 12 to 14 may comprise fiducial, mechanical pins, mechanical holders, or mechanical slots to place any optical elements attached to the fiber tips or at a distance from the fiber tips. The mechanical structure holds the various components to facilitate precise optical alignment.

FIGS. 15a-c show examples of micro-LED or PD interfaces with single fibers 150, and FIGS. 15d-f show examples of micro-LED or PD interfaces with imagining fibers 140. The interface for each fiber in an array of fibers placed in a ferrule 142 would be similar to the configurations shown in FIGS. 15a-c. The semiconductor-based element 147, i.e., micro-LED or micro-PD, may be encapsulated within micro-lens 148 or other structures 149 to match the refractive index of the semiconductor part to the fiber core and increase the light extraction from the LED 147. The area between the micro-lens 148 and the core of the fibers 150, 140 (FIGS. 15a and 15d) or micro-LED 147 and fiber (FIGS. 15b and 15e) or micro-LED and optical element on the tip of the fiber 150, 140 (FIGS. 15c and 15f) may be filled with a material 149 to match the refractive index mismatch and fill out the air gap, disabling the air interface. The material 149 may also be an ultraviolet (UV) curable glue holding the fiber firmly in the ferrule and/or mechanical holder 142. A mechanical holder or ferrule 142 sets the spacing between the fiber tip and/or LED to ensure maximum light collection by the entire NA of the fiber 140, 150. The assemblies include but are not limited to, adding one or an array of microlens (FIGS. 15a and 15d), index-matching material (FIGS. 15b and 15e), or an optical element to the tip of the fiber (FIGS. 15c-f).

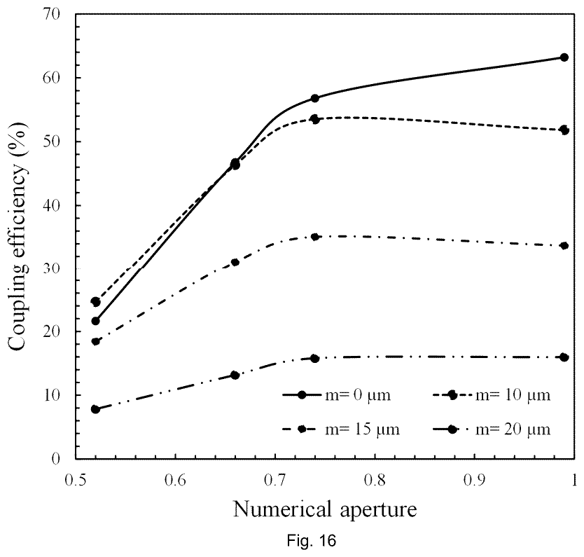

FIG. 16 shows examples of simulation results illustrating the influence of high NA in collecting the optical power of LEDs. FIG. 16 shows a simulation of coupling efficiency as a function of numerical aperture (NA) for various optomechanical misalignments. Four examples of fiber models with NA ranging from 0.5 to about 1 are generated in Ansys-Zemax software, from ANSYS, Inc., U.S.A. to model the influence of NA using geometrical ray tracing. The diameter of the fiber core and claddings in all models is set to 45μm and 5μm, respectively. A model of a circular surface-emitting LED, with a diameter of 20μm, generating a Lambertian spatial pattern (without lens) is used. The spacing between the LED and the fiber tips is approximately 10μm. The solid line (no misalignment) shows the coupling efficiency for various NA when the LED and the fibers are centered perfectly. When there is no misalignment, the coupling efficiency significantly increases by increasing the NA; for instance, the coupling efficiency doubles when the NA increases from 0.5 to 0.7 for the example simulated in FIG. 16. The other curves in FIG. 16 compares cases where the LED is laterally shifted in both vertical and horizontal directions by m=10μm, 15μm, and 20μm. The misalignment up to 10μm shows insignificant changes (less than 5%) in coupling efficiency for NA values between 0.5 and 0.8. When the misalignment increases to 15μm, the coupling efficiency drops significantly for larger NAs (larger than 0.6); however, the coupled power is still 1.5 times more than the 0.5 NA. Due to higher coupling efficiency, higher NA fibers are excellent candidates for a passive alignment for a scalable product where higher alignment tolerance is needed.

In one example, the fibers may be any polymer, plastic, or glass fibers. The NA of the fibers may be in the range of 0.2 to 1. The fibers may have any diameter ranging from 40μm to several millimeters.

In one example, the length of the fibers ranges from 1 meter to 10 meters.

In one example, the ferrules are made with plastics, ceramic, or any metal. The material generally satisfies the thermal characteristics mandated by the environment where the product will be used. The ferrule maintains the required optical alignment precision in the operating environment.

In one example, the ferrules or the fiber holders are made using laser material processing in glass with micron to sub-micron resolutions.

In one example, as shown in FIGS. 15a-15f the material 149, filling the gap between may have a refractive index of 1.5 to 2, with the maximum optical transmission at the operating wavelength. In other examples, the material may be replaced by an air gap.

In one example, the imaging fibers may have more than one core, from 500 to tens of thousands of cores. Plastic or glass imaging fibers may also be used.

In one example, the two-dimensional (2D) arrays of the fibers may be used with a pitch ranging from 40μm to several millimeters.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Accordingly, the above description of example implementations does not define or constrain this disclosure. Other changes, substitutions, and alterations are also possible without departing from the spirit and scope of this disclosure.

1. An optical interconnect system comprising:
at least one light source for emitting light, the light comprising a distribution pattern having a predefined divergence angle;
at least one communication medium for transmitting the light, wherein the at least one communication medium comprises a numerical aperture, and wherein at least one of the numerical aperture, the at least one light source, the predefined divergence angle, and the at least one communication medium, is dimensioned to minimize loss of optical power coupling of the light into the at least one communication medium;
at least one light detector for receiving the light from the at least one communication medium;
at least one optomechanical alignment system configured to optimize collection of the light at the least one light detector.

2. The optical interconnect system of claim 1, wherein the at least one optomechanical alignment system comprises at least one optical component and at least one mechanical component.

3. The optical interconnect system of claim 1, wherein the at least one communication medium is a short-distance communication link.

4. The optical interconnect system of claim 3, wherein the numerical aperture ranges from 0.5 to about 1.

5. The optical interconnect system of claim 3, wherein the short-distance communication link is associated with at least one of chip-to-chip communication or board-to-board communication, thereby minimizing impact of optical dispersion, and thereby enabling transmission of the light in higher bandwidth conditions.

6. The optical interconnect system of claim 1, wherein the at least one light source comprises at least one of a LED, a LED array, a micro-LED and a micro-LED array.

7. The optical interconnect system of claim 1, wherein the at least one light detector comprises at least one of a photodetector, a photodetector array, a micro-a photodetector, and a micro photodetector array.

8. The optical interconnect system of claim 2, wherein the at least one optical component comprises at least one of a coupling element and an index matching material between the at least one light source and the at least one communication medium.

9. The optical interconnect system of claim 2, wherein the at least one mechanical component holds the at least one communication medium, wherein the at least one mechanical component is configurable to align the at least one communication medium with respect to the at least one light source plane or the at least one light detector.

10. The optical interconnect system of claim 9, wherein the at least one mechanical component comprises an alignment fiducial for aligning the at least one light source plane or the at least one light detector with the at least one communication medium.

11. The optical interconnect system of claim 10, wherein the least one light source is held by the at least one mechanical component and positioned at a first position to maximize light collection by the entire numerical aperture of the at least one communication medium.

12. The optical interconnect system of claim 1, wherein the at least one communication medium comprises high numerical aperture optical fibers.

13. The optical interconnect system of claim 12, wherein the high numerical aperture optical fibers comprise at least one of glass, plastic, and polymer fibers, for high data rate short-distance communication links.

14. The optical interconnect system of claim 13, wherein the high numerical aperture optical fibers allow for higher tolerance of optomechanical misalignment, facilitate passive alignment of the at least one optomechanical alignment system.

15. The optical interconnect system of claim 14, wherein the at least one optomechanical alignment system comprises mechanical ferrules to hold the high numerical aperture optical fibers.

16. The optical interconnect system of claim 3, wherein the at least one communication medium comprises imaging fiber, whereby the imaging fiber allows for setting a plurality of parallel optical links without fabricating an array of single-core fibers precisely aligned to the least one light source.

17. The optical interconnect system of claim 16, wherein the plurality of parallel optical links are placed in single imaging fibers for short-distance optical communication ranging from 1 to 10 meters, wherein the short-distance optical communication exhibits low latency and low power consumption.

18. A method for assembling an optical interconnect system, the method comprising the steps of:
providing at least one light source for emitting light, wherein the emitted light comprises a distribution pattern;
determining a diameter and a divergence angle of the at least one light source;
providing at least one communication medium for transmitting the light, wherein the at least one communication medium comprises a numerical aperture, and wherein at least one of the numerical aperture, the at least one light source, the predefined divergence angle, and the at least one communication medium, is dimensioned to minimize loss of optical power coupling of the light into the at least one communication medium;
providing at least one light detector for receiving the light from the at least one communication medium; and
providing at least one alignment system to optimize collection of the light at the least one light detector.

19. The method of claim 18, wherein the at least one alignment system comprises at least one optical component and at least one mechanical component configured.

20. The method of claim 18, further comprising a step of modelling the distribution pattern to determine the divergence angle and light coupling efficiency into the at least one communication medium.

21. The method of claim 18, further comprising a step of determining parameters of the at least one optical component to minimize mismatch between a surface of the at least one light source and the at least one communication medium.

22. The method of claim 21, further comprising a step of estimating a diameter of the at least one light source and the divergence angle based on the parameters.

23. The method of claim 22, further comprising a step of determining a refraction angle due to the refractive index mismatch between the at least one light source, the at least one communication medium and an index matching material between the at least one light source and the at least one communication medium.

24. The method of claim 23, further comprising a step of determining a divergence angle due to the refractive index mismatch between the at least one light source, the at least one communication medium and an index matching material between the at least one light source and the at least one communication medium.

25.-35. (canceled)
